(19) United States
(12) Patent Application Publication
(10) Pub. No.: US 2005/0201297 A1
(43) Pub. Date: Sep. 15, 2005

(54) Diagnosis of embedded, wireless mesh networks with real-time, flexible, location-specific signaling

(76) Inventor: Cyrus Peikari, Dallas, TX (US)

Correspondence Address: Cyrus Peikari, 6242 Walnut Hill Ln, Dallas, TX, 75230, US

(21) Appl. No.: 11/007,513

(22) Filed: Dec. 8, 2004

Related U.S. Application Data
(60) Provisional application No. 60/528,992, filed on Dec. 12, 2003.

(51) Int. Cl. H04L 12/28

(52) U.S. Cl. 370/242

(57) ABSTRACT

A system for optimizing the security of data communication on wireless mesh networks invention uses existing mesh network nodes to control new nodes that attempt to join the network. In a preferred embodiment, this is achieved by (1) testing that a new node is “clean” before allowing it to join the wireless mesh network by scanning the new node for viruses, checking for security patches, etc., (2) quarantining an “infected” node from joining the wireless mesh network until it is cleaned, (3) signaling other nodes in the existing mesh network that a node is either “infected” or “clean”, (4) cleaning a new node by supplying it with antivirus software, vendor patches, etc. from nearby nodes in the existing wireless mesh network, (5) updating the wireless mesh network in real time with a list of clean and infected nodes, and (6) performing the above steps without the need for a central, controlling server.

### REFERENCES

U.S. patents:
U.S. Pat. No. 5,842,002
Schnurer, et al.
Computer virus trap
Nov. 24, 1998
U.S. Pat. No. 5,398,196
Chambers
Method and apparatus for detection of computer viruses
Mar. 14, 1995
U.S. Pat. No. 5,379,414
Adams
Systems and methods for FDC error detection and prevention
Jan. 3, 1995
U.S. Pat. No. 5,278,901
Shieh, et al
Pattern-oriented intrusion-detection system and method
Jan. 11, 1994
U.S. Pat. No. 5,121,345
Lentz
System and method for protecting integrity of computer data and software
Jun. 9, 1992
   U.S. patent applications:
20030033536
Pak, Michael C.; et al
Virus scanning on thin client devices using programmable assembly language
Feb. 13, 2003
20020083334
Rogers, Antony John; et al.
Detection of viral code using emulation of operating system functions
Jun. 27, 2002
20030079145
Platform abstraction layer for a wireless malware scanning engine
Kouznetsov, Victor; et al.
Apr. 12, 2002

### CROSS-REFERENCE TO RELATED APPLICATIONS

Ser. No. 09/847,571
Self-optimizing the diagnosis of data processing systems by flexible multitasking
Peikari Cyrus
May 2, 2001
60/476,259
Protecting embedded processing systems with real-time, heuristic, integrated virus scanning
Peikari Cyrus
Jun. 4, 2003
60/497,113
Protecting Data Processing Systems with Distributed, Bayesian, Heuristic Malware Detection
Peikari Cyrus
Aug. 22, 2003
Protecting Data Networks with Embedded, Wireless Mesh Malware Detection
Peikari Cyrus
Dec. 8, 2003

### STATEMENT REGARDING FEDERALLY SPONSORED RESEARCH OR DEVELOPMENT

Not Applicable

### FIELD OF THE INVENTION

The invention relates to the protection of data processing systems. In particular, the invention is directed to increasing the security of computer processing networks, especially by protecting against malicious code such as computer viruses, worms and Trojan horses on networks of embedded, mesh wireless devices.

### BACKGROUND OF THE INVENTION

Computer processing systems (such as a desktop computers and computer networks) are vulnerable to malicious code and programs such as computer viruses, worms and Trojan horses. A common method of protection against malicious code involves using protection programs such as a virus scanner. For example, the most common form of virus scanner operates by scanning data in binary files for unique strings or signatures of unique byte sequences. In addition, preventing attacks from computer viruses and worms requires that a computer system be updated frequently with recent software security patches, and that a computer system be virus scanned frequently with up-to-date virus signatures.

Embedded, wireless devices such as personal data assistants (PDAs) and advanced mobile phones (smartphones) are becoming prevalent. In fact, embedded operating systems are beginning to allow even miniature devices like watches and toasters to run advanced software and to communicate using wireless radio frequency (RF). Like their desktop computing counterparts, these tiny devices are also vulnerable to malicious programming code such as computer viruses. In fact, the first viruses and Trojans for smartphones and PDAs have already appeared.

In contrast to traditional, wired networks, embedded wireless mesh networks present a new level of complexity and danger. In a mesh network, nodes can automatically connect to other nearby nodes using a wireless, radio frequency (RF) connection. This means that they can much more easily transfer malware infections such as computer viruses and worms. In fact, many more devices are currently being manufactured that have this mesh wireless ability embedded directly into the central processing unit (CPU) and other hardware.

Unfortunately, because these devices interconnect freely, they increase the vulnerability of the entire mesh network to malware attacks such as viruses and worms. The prior art has no provision for automatically protecting wireless mesh networks as a whole from malware attacks. In addition, the rise of peer-to-peer networking technology allows widely distributed computing devices to upload potentially hostile software (such as viruses and Trojans) to the rest of the Internet community. With current security systems in place, computer viruses and worms are still causing over $10 billion per year in damage. This problem will be greatly compounded as wireless connectivity brings together hundreds of millions more embedded devices.

### BRIEF SUMMARY OF THE INVENTION

In order to overcome this limitation of these prior art security systems, the present invention allows for automatic protection of the wireless mesh network as a whole. In the present invention, a new device (“node”) will not be allowed to connect to other nodes in the mesh network until it successfully authenticates. In order to authenticate, the new node must first provide (“signal”) neighboring nodes with evidence that it is “clean”. “Clean”, in this context, might include any of the following, which are examples only and do not limit the scope of the invention claimed:
a) The new node has installed and recently applied the latest vendor security patch and/or
b) The new node has updated the latest virus signatures and recently scanned itself for viruses and/or
c) The new node has sent a snapshot of its current, “clean” baseline system state to neighboring nodes.

In the present invention, each node in the mesh network has a known baseline system “snapshot” of every node to which it is directly connected. No node will associate with another unless it has proof that the other node has recently undergone “cleaning.” Then, in the case of a malware attack, the system can automatically and specifically defend itself For example, if a computer worm attacks one of the nodes in the mesh network, the infected node (or the node under attack) detects the change in its baseline state caused by the worm. This could be any number of changes including changes to the node's file system, a change in the node's random access memory (RAM), a change in the node's open communication ports, etc. Thus, when an attack such as a worm triggers any change from the node's baseline “clean” state, any or all of the following protocols may be followed:
1) The change is recorded and immediately sent (signaled) to other nodes to which the infected node is directly connected
2) The directly connected, “clean” neighboring nodes each immediately send a signal to disconnect from the infected node. The infected node is thus temporarily isolated (“quarantined”) from the rest of the wireless mesh network.
3) The directly connected, “clean” neighboring nodes that have just disconnected from the infected node will now each broadcast a signal to the rest of the wireless mesh network. This is a “blacklist” signal that will keep the infected node from associating with any other node in the mesh.
4) Meanwhile, the infected node automatically updates its antivirus signatures and security patches, if available, and then performs a local system virus scan.
5) When “quarantined” node is made clean, it can then optionally attempt to authenticate to the mesh network again as if it were a new, “clean” node.

The current invention, in addition to being automatic, is also flexible. This is because only infected nodes are taken out of the mesh, and then only for a short period of time until they are cleaned. Thanks to signaling, the current invention is also location-specific, which means that only the infected node is temporarily shut down—the rest of the mesh network continues to operate without interruption. In addition, throughout the above signaling process, cryptographic digital signatures and other methods may be used to verify authentication.

The prior art has no provision for protecting wireless mesh networks as a whole. In addition, the prior art has no provision for flexible, location-specific diagnosis of wireless mesh networks. Furthermore, the prior art has never provided for policy control on a mesh network, without using some sort of centralized policy controller such as a server. The current invention thus overcomes limitation in the prior art for protecting embedded, wireless mesh networks.

In a second embodiment of the preferred invention, the current invention allows for more “specificity of action.” In other words, instead of completely quarantining the infected node, the system can be configured to quarantine only certain aspects of the infection (such as blocking a certain communication port from the infected node) and to signal other nodes in the wireless mesh network to do the same.

The present invention overcomes the disadvantages of the prior art, by offering a method and apparatus for protecting against malicious code such as computer viruses, worms and Trojan horses on mesh networks of embedded, wireless devices.

This embodiment can be achieved by the following preferred system for:
1) Preventing a new node from joining the existing mesh network until it authenticates that it is “clean”, i.e., that it has performed all of the following: a) recently installed and applied the latest vendor security patch, b) updated the latest virus signatures and recently scanned itself for viruses, and c) sent a snapshot of its current, “clean” baseline system state to neighboring nodes.
2) Detecting any change in a node's baseline state caused by an attack such as a computer worm
3) Determining infection based on criteria such as a change in the node's file system, a change in the node's random access memory (RAM), a change in the node's open communication ports, etc.
4) Recording the change from baseline and immediately sending (signaling) the change to other nodes to which the infected node is directly connected
5) Immediately sending a signal from each of the directly connected, “clean” neighboring nodes to disconnect from the infected node, thus temporarily isolating (“quarantining”) the infected node from the rest of the wireless mesh network.
6) Broadcasting a blacklist signal from each of the directly connected, “clean” neighboring nodes in order to keep the infected node from associating with any other node in the mesh.
7) Automatically updating antivirus signatures and security patches on the infected node, if available, and then performing a local system virus scan until clean.
8) Automatically re-attempting to authenticate the quarantined node to the mesh network again as if it were a new, “clean” node in step (1) one above.
9) Periodically verifying that each node has a recent “cleaned” snapshot of each neighboring node to which it is directly connected.
10) Alternately requiring digital signatures or other means of authentication
11) Optionally allowing signaling and protection to occur without any direction from a centralized server.
12) Optionally blocking only specific aspects or communication protocols of the infected node.

### BRIEF DESCRIPTION OF THE DRAWING

The present invention may be understood more clearly from the following detailed description, which is solely for explanation and should not be taken to limit the invention to any specific form thereof, taken together with the accompanying drawing, wherein:

FIG. 1 illustrates a wireless mesh network (WLAN) that is configured to utilize the present invention.

### DETAILED DESCRIPTION OF THE INVENTION

The operation of the present invention will now be described in conjunction with the Drawing Figure.

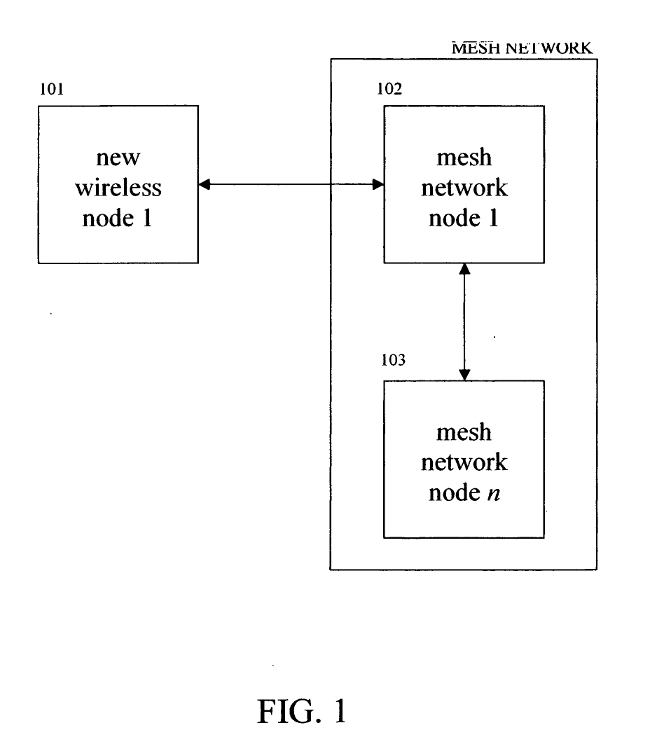

FIG. 1 is a flow diagram illustrating an embodiment of the present invention, which protects wireless mesh networks.

Step 101 represents a new node that attempts to authenticate to the nearest part of the existing mesh network at step 102 over a radio frequency (RF) connection. When the new node at step 101 attempts to connect to one of the existing nodes at step 102, the protection mechanism automatically begins. The existing node at step 102 first checks to see if the new node at step 101 has updated its security, including an updated virus scanner, firewall, vendor patches, etc.

If the new node at step 101 does not have updated security, then the node at 102 automatically quarantines it until it is updated. The node at 102 can also optionally provide the node at 101 with the information or files needed to update.

Once the new node at step 101 is updated, or after an optional period of time, it can attempt to re-authenticate with one of the nodes in the existing mesh network, such as the node at step 102.

During any step of the process, or at fixed intervals, or in real time, the various nodes in the existing wireless mesh network communicate with each other. For example, after the node at step 102 rejects the node at step 101 from joining the network, then the node at step 102 can signal other nodes in the network (such as the nearby node at step 103) that the new node at step 101 is “blacklisted” for a period of time.

Once the new node at step 101 has adequately updated its security, it can then successfully authenticate to any node on the mesh network.

1. An apparatus configured to protect a wireless mesh network, said wireless mesh network comprising at least one node, said apparatus comprising:
a. means for detecting any change in the baseline state of said at least one node;
b. means for determining whether said at least one node is infected, in response a change in the baseline state detected by said means for detecting;
c. means for quarantining said at least one node, when said means for determining determines that said at least one node is infected;
d. means for determining whether a new node is infected before allowing it to join said wireless mesh network;
e. means for quarantining said new node, when said means for determining determines that said new node is infected;
wherein said means for quarantining said at least one node and said means for quarantining said new node occurs by nearby nodes sending signals to disconnect from said at least one node or said new node;
f. means for signaling comprising means for updating said wireless mesh network in real time with a list of clean and infected nodes;
g. means for cleaning said wireless mesh network by supplying data to infected nodes to either remove the infection or to render the infection harmless, wherein said data is sent to infected nodes from nearby nodes in the existing wireless mesh network.

2. The apparatus of claim 1, wherein said apparatus operates without the need for a central, controlling server.

3. An method for protecting a wireless mesh network, said wireless mesh network comprising at least one node, said method comprising:
a. detecting any change in the baseline state of said at least one node;
b. determining whether said at least one node is infected, in response a change in the baseline state detected by said step of detecting;
c. quarantining said at least one node, when said means for determining determines that said at least one node is infected;
d. determining whether a new node is infected before allowing it to join said wireless mesh network;
e. quarantining said new node, when said means for determining determines that said new node is infected;
wherein said quarantining said at least one node and said quarantining said new node occurs by nearby nodes sending signals to disconnect from said at least one node or said new node;
f. updating said wireless mesh network in real time with a list of clean and infected nodes;
g. supplying data to infected nodes to either remove the infection or to render the infection harmless, wherein said data is sent to infected nodes from nearby nodes in the existing wireless mesh network.

4. An apparatus configured to protect a wireless mesh network, said wireless mesh network comprising at least one node, said apparatus comprising:
a. means for detecting any change in the baseline state of said at least one node;
b. means for determining whether said at least one node is infected, in response a change in the baseline state detected by said means for detecting;
c. means for quarantining said at least one node, when said means for determining determines that said at least one node is infected;
d. means for signaling comprising broadcasting the status of said at least one node to other nodes in said wireless mesh network;
e. means for cleaning said at least one node by supplying data from nearby nodes to said at least one node to either remove the infection or to render the infection harmless.

5. The apparatus of claim 4, wherein said means for quarantining further comprises nearby nodes sending signals to disconnect from said at least one node.

6. The apparatus of claim 5, wherein said at least one node is allowed to be reconnected to said wireless mesh network when said at least one node is determined to be clean.

7. The apparatus of claim 6, wherein said at least one node is determined to be clean when by having updated virus signatures.

8. The apparatus of claim 6, wherein said at least one node is determined to be clean when by having updated vendor security patches,

9. The apparatus of claim 6, wherein said at least one node is determined to be clean when by having an updated firewall.

10. The apparatus of claim 4, wherein said wireless mesh network operates without a central server or a central controller.

11. The apparatus of claim 4, wherein said means for signaling updates said wireless mesh network in real time with a list of clean and infected nodes.

12. The apparatus of claim 4, further comprising
f. means for determining whether a new node is infected before allowing it to join said wireless mesh network;
e. means for quarantining said new node, when said means for determining determines that said new node is infected.

13. The apparatus of claim 7, wherein said new node is allowed to be connected to said wireless mesh network when said new node is determined to be no longer infected.

14. The apparatus of claim 4, wherein said data is selected from the group consisting of (a) antivirus software and (b) vendor patches.

15. A method for protecting a wireless mesh network, said wireless mesh network comprising at least one node, said method comprising:
a. detecting any change in the baseline state of said at least one node;
b. determining whether said at least one node is infected, in response a change in the baseline state detected by said step of detecting;
c. means for quarantining said at least one node, when said step of determining determines that said at least one node is infected;
d. means for signaling comprising broadcasting the status of said at least one node to other nodes in said wireless mesh network;
e. means for cleaning said at least one node by supplying data from nearby nodes to said at least one node to either remove the infection or to render the infection harmless.

16. The method of claim 15, wherein said step of quarantining further comprises nearby nodes sending signals to disconnect from said at least one node.

17. The method of claim 16, wherein said at least one node is allowed to be reconnected to said wireless mesh network when said at least one node is determined to be clean.

18. The method of claim 15, wherein said step of signaling updates said wireless mesh network in real time with a list of clean and infected nodes.

19. The method of claim 15, further comprising
f. determining whether a new node is infected before allowing it to join said wireless mesh network;
e. quarantining said new node, when said step of determining determines that said new node is infected.

20. The method of claim 15, wherein said wireless mesh network operates independently of any centralized controller.
